(19) United States
(12) Patent Application Publication
(10) Pub. No.: US 2026/0346292 A1
(43) Pub. Date: Nov. 5, 2026

(54) Mounting Base, Shower Head, and Shower Head Assembly

(71) Applicant: FUJIAN DOMOO SANITARY WARE TECHNOLOGY CO., LTD, Quanzhou, Fujian (CN)

(72) Inventors: Xiaofa Lin, Quanzhou, Fujian (CN); Xiaoshan Lin, Quanzhou, Fujian (CN); Zhiwei Chen, Quanzhou, Fujian (CN); Qiqiao Liu, Quanzhou, Fujian (CN); Pansheng Liang, Quanzhou, Fujian (CN); Xiaoqing Deng, Quanzhou, Fujian (CN)

(21) Appl. No.: 19/505,606

(22) PCT Filed: Sep. 30, 2022
(86) PCT No.: PCT/CN2022/123556

§ 371 Date: Jan. 26, 2026

(30) Foreign Application Priority Data
Aug. 25, 2022 (CN) 202211026782.7

(51) Int. Cl. B05B 15/62; B05B 1/18

(52) U.S. Cl. CPC B05B 15/62; B05B 1/182

(57) ABSTRACT

A mounting base, a shower head, and a shower head assembly. The mounting base comprises a base body, a first magnetic member, and a first fastener; the first magnetic member and the first fastener are both mounted to the base body; the first magnetic member is arranged to be magnetically attracted to a mounting member mounted to the base body; the first fastener is arranged to be fastened to the mounting member.

### CROSS-REFERENCE TO RELATED APPLICATION

The present application is a U.S. National Phase Entry of International Application No. PCT/CN2022/123556 having an international filing date of Sep. 30, 2022, which claims priority to Chinese Patent Application No. 202211026782.7 filed on Aug. 25, 2022. Contents of the above-identified application are incorporated into the present application by reference.

### TECHNICAL FIELD

The present disclosure relates to, but is not limited to, the field of shower equipment, and particularly relates to, but is not limited to, a mounting base, a shower head, and a shower head assembly.

### BACKGROUND

In some technologies, magnets are respectively installed in a shower head and a wall seat (used to install the shower head), and a repeatable pick-and-place connection between the shower head and the wall seat can be realized by using magnetic attraction force. The magnetic attraction connection mode has a problem that the magnetic attraction force of the magnets in a positive direction (perpendicular to attraction surfaces arranged oppositely when the magnets are attracted to each other) is large enough, but the magnetic force in a longitudinal direction (parallel to the attraction surfaces when the magnets are attracted to each other) is small, so that the shower head is easy to fall under the action of gravity. In order to increase the magnetic force of the magnetic attraction connection mode in the longitudinal direction, some solutions adopt an overall increase of the magnetic attraction force, which will make it difficult to remove the shower head.

### SUMMARY

The following is a summary of subject matter described in detail herein. The summary is not intended to limit the protection scope of the claims.

A mounting base includes: a base body, a first magnetic member and a first snap-fit member, the first magnetic member and the first snap-fit member being both mounted to the base body. The first magnetic member is configured to be magnetically attracted to a mounting member mounted to the base body, and the first snap-fit member is configured to snap-fit with the mounting member.

A shower head includes: a shower head body, a second magnetic member and a second snap-fit member, the second magnetic member and the second snap-fit member being both mounted to the shower head body. The second magnetic member is configured to be magnetically attracted to the first magnetic member of the above-described mounting base, and the second snap-fit member is configured to snap-fit with the first snap-fit member of the mounting base.

A shower head assembly includes the above-described mounting base and the above-described shower head configured to be mountable to the mounting base.

Other aspects will become apparent after reading and understanding drawings and detailed description.

### BRIEF DESCRIPTION OF DRAWINGS

The drawings are used for providing a further understanding of technical solutions of the present disclosure, and constitute a part of the specification. They are used together with embodiments of the present disclosure to explain the technical solutions of the present disclosure, and do not constitute a restriction on the technical solutions of the present disclosure.

FIG. 1 is a structural schematic view of a shower head assembly according to an embodiment of the present application, wherein a mounting base and a shower head are in a separated state;

FIG. 2 is a schematic view of a cross-sectional structure of the shower head assembly shown in FIG. 1;

FIG. 3 is a partially enlarged schematic view of a structure of part A in FIG. 2;

FIG. 4 is a schematic view of a cross-sectional structure of the shower head assembly shown in FIG. 1, wherein the shower head is mounted on the mounting base;

FIG. 5 is a partially enlarged schematic view of a structure of part B in FIG. 4;

FIG. 6 is an exploded structural schematic view of the shower head assembly shown in FIG. 1;

FIG. 7 is another exploded structural schematic view of the shower head assembly shown in FIG. 1;

FIG. 8 is a structural schematic view of a first snap-fit member and a face cover of the mounting base in the shower head assembly shown in FIG. 1;

FIG. 9 is a three-dimensional structural schematic view of the first snap-fit member in FIG. 8;

FIG. 10 is a structural schematic view of the face cover in FIG. 8;

FIG. 11 is a structural schematic view of a second snap-fit member of the shower head in the shower head assembly shown in FIG. 1;

FIG. 12 is a structural schematic view of the shower head assembly shown in FIG. 1, wherein the shower head is mounted on the mounting base;

FIG. 13 is a structural schematic view of the shower head assembly shown in FIG. 1 in its use state; and

FIG. 14 is a structural schematic view of a mounting base according to another embodiment of the present application.

### REFERENCE SIGNS

100—mounting base, 200—shower head;
1—base body, 11—support seat, 12—face cover, 121—first slot, 1211—first wall surface, 122—second slot, 123—first mounting groove, 124—rotary support portion, 13—accommodation cavity, 14—magnetic member bracket, 15—insertion portion, 2—first magnetic member, 3—first snap-fit member, 31—snap-fit member body, 32—driving portion, 321—driving surface, 33—snap-fit portion, 34a, 34b—rotary connection portion, 4—elastic resetting member, 5—rotation axis of first snap-fit member, 6—center line of first magnetic member, 6—I-central axis of first circular arc groove, 6—II-central axis of circular arc-shaped protrusion, 6—III-central axis of second circular arc groove;
7—shower head body, 71—spray head, 72—gripping portion, 8—second magnetic member, 81—center line of second magnetic member, 9—second snap-fit member, 91—snap-fit groove, 92—pushing protrusion, 921—second wall surface, 9—I-central axis of third circular arc groove.

### Detailed Description

Technical solutions in embodiments of the present application will be clearly and completely described with reference to the drawings in the embodiments of the present application. Apparently, the described embodiments are only part of the embodiments of the present application, but not all of them. Based on the embodiments of the present application, all other embodiments obtained by those of ordinary skills in the art without making creative efforts belong to the scope of protection of the present application.

In addition, the technical solutions of the different embodiments of the present application may be combined with each other, but it needs to be based on the realization by those of ordinary skills in the art. When the combination of technical solutions is contradictory or cannot be realized, it should be considered that such combination of technical solutions does not exist, nor within the scope of protection required by the present application.

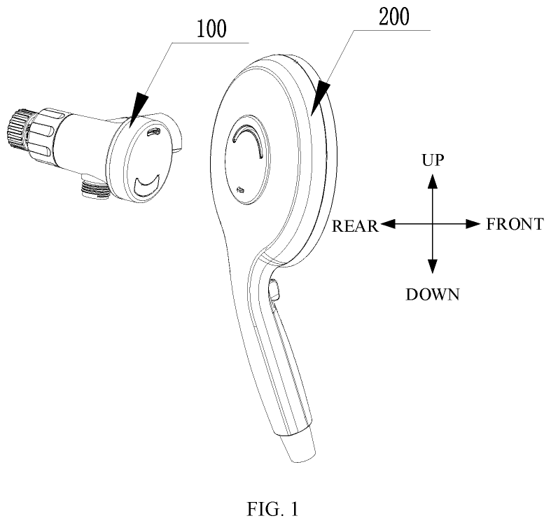

It should be noted that all directivity indications (such as up, down, front, rear, etc.) in the embodiments of the present application are only used to explain a relative positional relationship, movement and the like among different components under a specific posture (as shown in FIG. 1). If the specific posture is changed, the directivity indications are also changed accordingly.

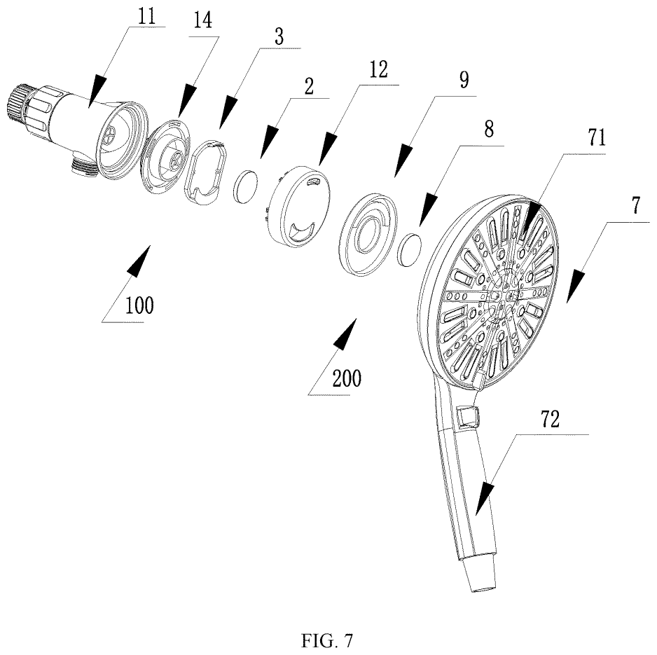

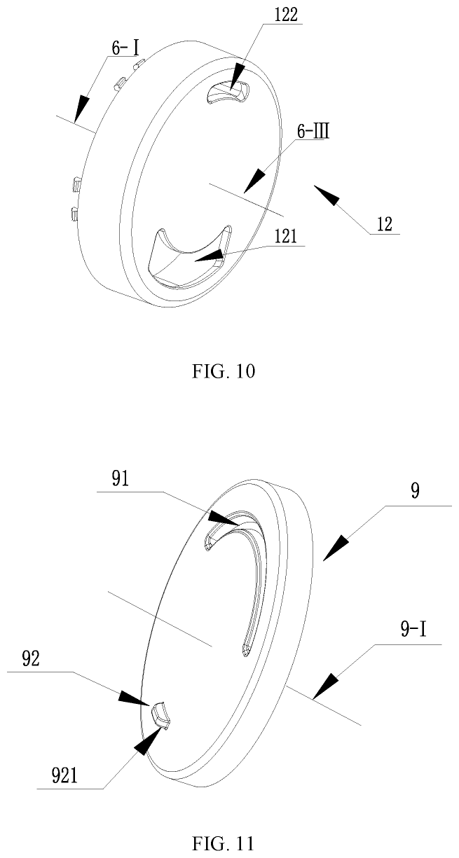

Referring to FIGS. 1 to 13, an exemplary embodiment of the present application provides a mounting base 100, a shower head 200, and a shower head assembly. The shower head 200 can be used cooperatively with the mounting base 100, and the shower head 200 can be installed on the mounting base 100 to form a shower head assembly, that is, the shower head assembly includes the shower head 200 and the mounting base 100.

It should be understood that the mounting base 100 described in the embodiment of the present application can not only be used cooperatively with the shower head 200, but also be applicable to other mounting members, which can be mounted on the mounting base 100.

Hereinafter, it takes the shower head 200 as an example for illustration.

As shown in FIGS. 1 to 12, an exemplary embodiment of the present application provides a mounting base 100, including a base body 1, a first magnetic member 2, and a first snap-fit member 3, and the first magnetic member 2 and the first snap-fit member 3 are both mounted to the base body 1. The first magnetic member 2 is configured to be magnetically attracted to the shower head 200 mounted to the base body 1, and the first snap-fit member 3 is configured to snap-fit with the shower head 200.

The mounting base 100 includes a first magnetic member 2 and a first snap-fit member 3. When the shower head 200 is mounted to the mounting base 100, the first magnetic member 2 can be magnetically attracted to a second magnetic member 8 of the shower head 200 (see below for detailed description). Under the guiding action of the magnetic attraction force, the first snap-fit member 3 can snap-fit with the shower head 200 to achieve magnetic attraction fixation and snap-fit fixation between the mounting base 100 and the shower head 200.

The mounting base 100 described in the embodiment of the present application is magnetically fixed to the shower head 200 mounted to the base body 1 by using the first magnetic member 2 and snap-fit with the shower head 200 by using the first snap-fit member 3. This can realize the connection mode of combining the magnetic attraction and snap-fit connection between the mounting base 100 and the shower head 200, improving the connection stability between the mounting base 100 and the shower head 200. This design can solve the problem that the shower head is easy to fall under the action of gravity when the shower head is only fixed by magnetic attraction, and the problem of the difficulty in removing the shower head caused by the excessive magnetic attraction force in some technologies.

The mounting base 100 described in the embodiment of the present application can be used cooperatively with the shower head 200 to realize the double fixation of the shower head 200 to the mounting base 100 by magnetic attraction and snap-fit, so that the fixation of the shower head 200 is more firm and the removal of the shower head 200 is convenient.

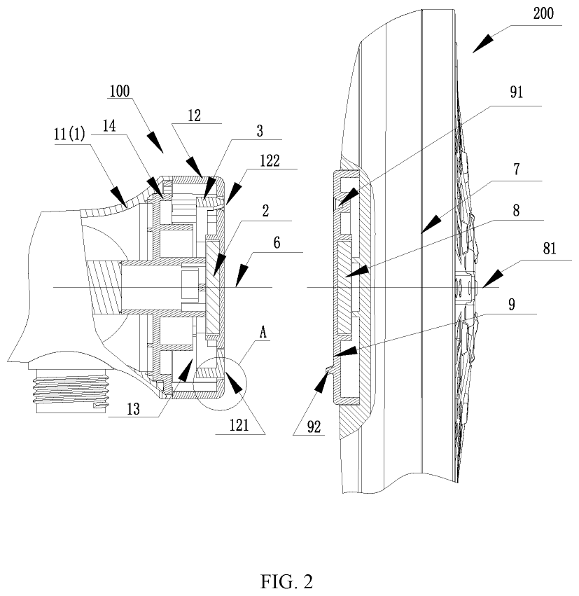

In some exemplary embodiments, as shown in FIGS. 2 to 9, the first snap-fit member 3 includes a snap-fit member body 31, and a driving portion 32 and a snap-fit portion 33 provided on the snap-fit member body 31.

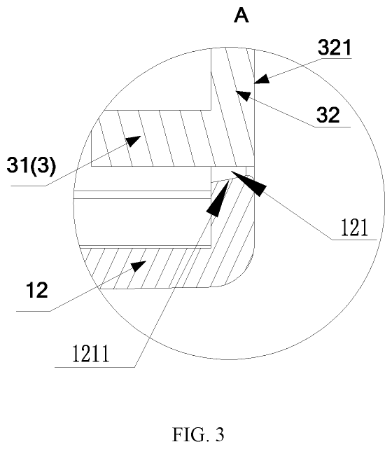

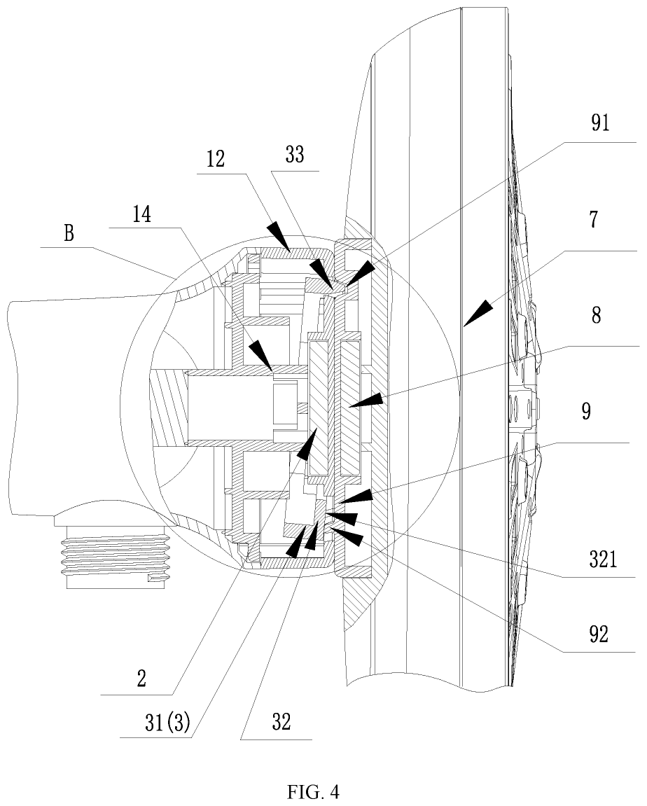

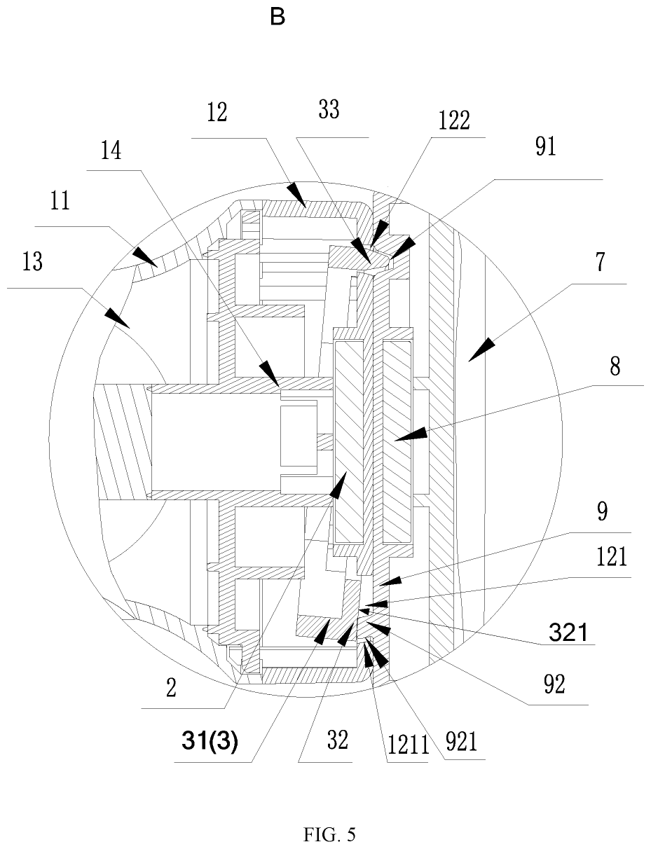

The snap-fit member body 31 is movably connected to the base body 1 so that the first snap-fit member 3 has a snap-fit state and a released state. As shown in FIGS. 4 and 5, in snap-fit state, the snap-fit portion 33 is snap-fitted with the shower head 200. As shown in FIGS. 2 and 3, in the released state, the snap-fit portion 33 is separated from the shower head 200.

The driving portion 32 is configured to be movable under the action of the shower head 200 to switch the first snap-fit member 3 from the released state to the snap-fit state.

In the first snap-fit member 3, the snap-fit member body 31 is movably connected with the base body 1 so that the snap-fit member body 31 can be moved relative to the base body 1 so as to allow the state of the first snap-fit member 3 to switch between the snap-fit state and the released state. The driving portion 32 and the snap-fit portion 33 are provided on the snap-fit member body 31. When the shower head 200 is installed on the mounting base 100, the shower head 200 can be fixed on the mounting base 100 under the action of magnetic attraction force. At the same time, the shower head 200 can apply an external force to the driving portion 32 to move the driving portion 32, and then drive the snap-fit member body 31 and the snap-fit portion 33 to move, so that the snap-fit portion 33 snap-fits with the shower head 200. This switches the first snap-fit member 3 from the released state to the snap-fit state to fix the shower head 200 to the mounting base 100.

As shown in FIGS. 1 to 3, at this time, the mounting base 100 and the shower head 200 have been separated, and the first snap-fit member 3 is in the released state. As shown in FIGS. 4 and 5, the shower head 200 is mounted on the base body 1, and the first snap-fit member 3 is in the snap-fit state.

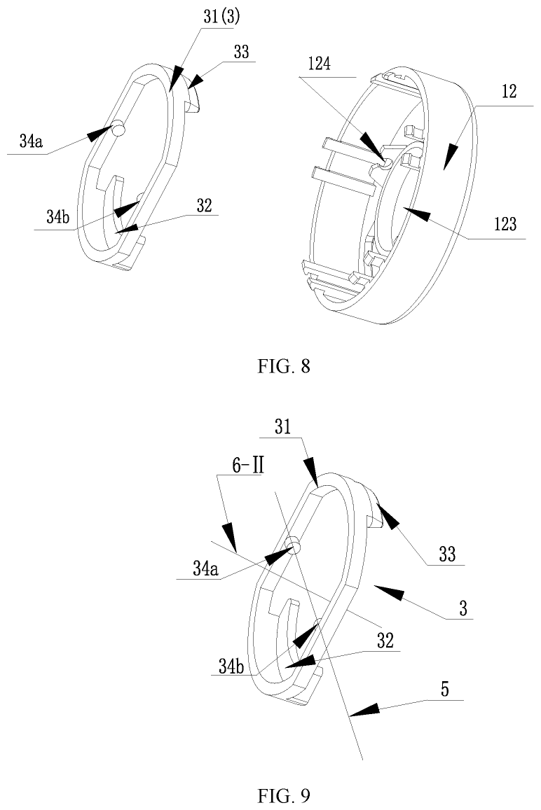

In some exemplary embodiments, as shown in FIGS. 8 and 9, the snap-fit member body 31 is provided with a rotary connection portion, and the rotary connection portion is rotatably connected with the base body 1. Two rotary connection portions may be provided, namely, rotary connection portions 34a and 34b respectively, and the rotary connection portions 34a and 34b are rotatably connected to the base body 1.

A rotation axis 5 of the first snap-fit member 3 perpendicularly intersects with a center line 6 (see FIG. 2) of the first magnetic member. The driving portion 32 and the snap-fit portion 33 are respectively located on both sides of the rotation axis 5 of the first snap-fit member 3 and are provided opposite to each other.

In the first snap-fit member 3, the rotary connection portions 34a, 34b on the snap-fit member body 31 are rotatably connected with the base body 1 to realize the rotary connection between the first snap-fit member 3 and the base body 1. Therefore, the snap-fit member body 31 can rotate relative to the base body 1, and the first snap-fit member 3 is similar to the form of a lever or a seesaw. One end (i.e., a front end) of the center line 6 of the first magnetic member close to the shower head 200 may be inclined downward, i.e., the center line 6 of the first magnetic member is inclined downward as a whole. The rotation axis 5 of the first snap-fit member 3 perpendicularly intersects with the center line 6 of the first magnetic member, and the driving portion 32 and the snap-fit portion 33 are respectively located on the upper and lower sides of the rotation axis 5 of the first snap-fit member 3. For example, the driving portion 32 can be located on the lower side of the rotation axis 5 of the first snap-fit member 3, the snap-fit portion 33 can be located on the upper side of the rotation axis 5 of the first snap-fit member 3, and the driving portion 32 and the snap-fit portion 33 are arranged opposite to each other. In this way, during the rotation of the snap-fit member body 31 relative to the base body 1, one of the driving portion 32 and the snap-fit portion 33 can move away from the first magnetic member 2, and the other of the driving portion 32 and the snap-fit portion 33 can move toward the first magnetic member 2. Therefore, an external force can be applied to the driving portion 32 through the shower head 200 to drive the snap-fit portion 33 to move, and to enable the first snap-fit member 3 to switch from the released state to the snap-fit state.

It should be understood that the rotary connection between the snap-fit member body 31 and the base body 1 is not limited to the rotary connection between the first snap-fit member 3 and the base body 1, and may also be other rotary connections. For example, in another exemplary embodiment, the first snap-fit member 3 is translationally connected to the base body 1. That is, the first snap-fit member 3 can translate relative to the base body 1 so that the first snap-fit member 3 can switch between the released state and the snap-fit state. The shower head 200 can drive the snap-fit member body 31 and the snap-fit portion 33 to translate through the driving portion 32, so as to realize the switching of the first snap-fit member 3 from the released state to the snap-fit state.

In some exemplary embodiments, the center of gravity of the first snap-fit member 3 is located on a side of the rotation axis 5 of the first snap-fit member 3 close to the driving portion 32, and the first snap-fit member 3 is configured to be held in the released state under the action of its own weight.

As shown in FIGS. 2 and 9, the center of gravity of the first snap-fit member 3 is configured to be located on the side of the rotation axis 5 of the first snap-fit member 3 close to the driving portion 32. For example, the center of gravity of the first snap-fit member 3 is located on the lower side of the rotation axis 5 of the first snap-fit member 3. That is, the first snap-fit member 3 is lighter at the upper part and heavier at the lower part as a whole, so that when the shower head 200 and the mounting base 100 are separated, the first snap-fit member 3 can be automatically reset under the action of its own weight and can be kept in the released state. This eliminates the need for a separate resetting member to automatically reset the first snap-fit member 3, which is advantageous to simplifying the structure of the mounting base 100. The state of the first snap-fit member 3 after resetting by gravity is shown in FIGS. 2 and 3.

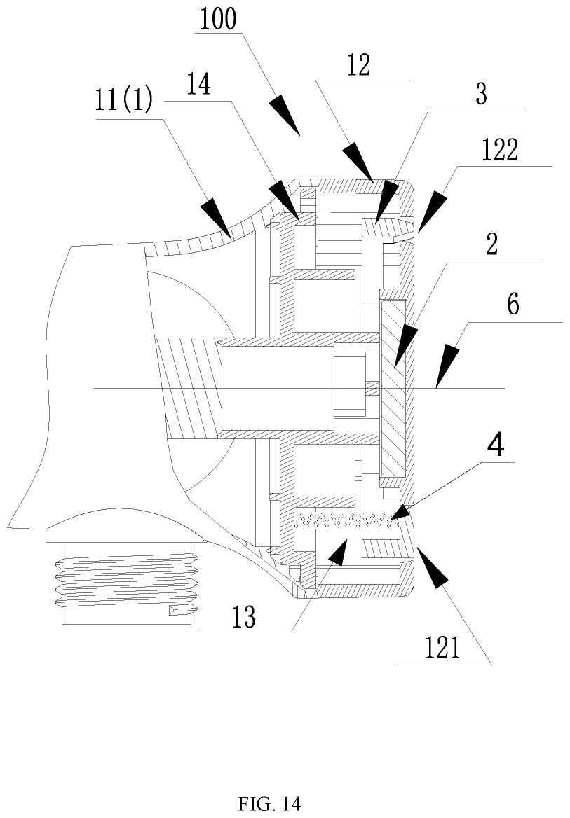

It should be understood that the first snap-fit member 3 not only may be automatically held in the released state by gravity but also may be automatically held in the released state by other means. For example, in another exemplary embodiment, as shown in FIG. 14, the mounting base 100 further includes an elastic resetting member 4 positioned between the first snap-fit member 3 and the base body 1, and the first snap-fit member 3 is configured to be held in a released state under the action of the elastic resetting member 4. That is, when the first snap-fit member 3 is not subjected to an external force applied by the shower head 200 (for example, the shower head 200 is separated from the mounting base 100), the first snap-fit member 3 can be kept in a released state under the action of the elastic force of the elastic resetting member 4 (as shown in FIG. 14). When the shower head 200 is mounted to the mounting base 100, the shower head 200 can apply an external force to the first snap-fit member 3 through the driving portion 32, and the first snap-fit member 3 can be displaced and the elastic resetting member 4 can be elastically deformed (for example, compressing or stretching the elastic resetting member 4), so that the first snap-fit member 3 switches from the released state to the snap-fit state. At this time, the snap-fit portion 33 of the first snap-fit member 3 can snap-fit with and be fixed to the shower head 200.

In some exemplary embodiments, as shown in FIGS. 2 to 10, the base body 1 includes a support seat 11 and a face cover 12, the support seat 11 and the face cover 12 cooperate to form an accommodation cavity 13, and the first snap-fit member 3 is installed in the accommodation cavity 13. The face cover 12 is provided with a first slot 121, and the first slot 121 is configured to allow the pushing protrusion 92 of the shower head 200 to pass through so as to push the driving portion 32. The face cover 12 is provided with a second slot 122, and the snap-fit portion 33 is configured to pass through the second slot 122 to snap-fit with the shower head 200.

In the mounting base 100, the support seat 11 and the face cover 12 of the base body 1 cooperate to form an accommodation cavity 13, and the first snap-fit member 3 is mounted in the accommodation cavity 13, which is beneficial to improving the aesthetics of the entire mounting base 100.

In order to enable the shower head 200 to apply an external force to the driving portion 32 of the first snap-fit member 3, the face cover 12 is provided with a first slot 121, and the first slot 121 corresponds to the position of the driving portion 32 and may be located at a lower portion of the face cover 12. As shown in FIGS. 4 and 5, when the shower head 200 is mounted to the mounting base 100, the shower head 200 can be fixed to the mounting base 100 under the action of magnetic attraction force. At the same time, under the guiding action of magnetic attraction force, the pushing protrusion 92 of the shower head 200 can pass through the first slot 121 to contact the driving portion 32 and push the driving portion 32, so that the first snap-fit member 3 as a whole rotates to realize the switching from the released state to the snap-fit state.

In order to enable the snap-fit portion 33 of the first snap-fit member 3 to snap-fit with and be connected to the shower head 200, the face cover 12 is provided with a second slot 122, and the second slot 122 corresponds to the position of the snap-fit portion 33 and may be located at the upper portion of the face cover 12. As shown in FIGS. 4 and 5, when the shower head 200 is mounted to the mounting base 100 and the pushing protrusion 92 of the shower head 200 pushes the first snap-fit member 3 to rotate, the snap-fit portion 33 can pass through the second slot 122 and extend out of the face cover 12 so as to snap-fit with and be connected to the shower head 200.

In some exemplary embodiments, as shown in FIGS. 2 to 5 and 8 to 9, the driving portion 32 includes a driving protrusion provided on an end surface on a side of the snap-fit member body 31 close to the face cover 12, and the snap-fit portion 33 includes a snap-fit protrusion provided on an end surface on a side of the snap-fit member body 31 close to the face cover 12.

As shown in FIGS. 2 and 3, in the released state, the driving portion 32 is configured to protrude into the first slot 121 and not protrude from an outer surface of the face cover 12. The snap-fit portion 33 is configured to protrude into the second slot 122 and not protrude from the outer surface of the face cover 12.

The first snap-fit member 3 can be an integral structure as a whole, and the driving portion 32 includes a driving protrusion provided on the snap-fit member body 31, and the snap-fit portion 33 includes a snap-fit protrusion provided on the snap-fit member body 31. As shown in FIGS. 2 and 3, when the first snap-fit member 3 is in the released state, the driving portion 32 is configured to protrude into the first slot 121 and not protrude from the outer surface of the face cover 12. For example, an end surface of a protruding end of the driving portion 32 can be configured to be flush with the outer surface of the face cover 12. The snap-fit portion 33 is configured to protrude into the second slot 122 and not protrude from the outer surface of the face cover 12. For example, an end surface of a protruding end of the snap-fit portion 33 may be configured to be flush with the outer surface of the face cover 12, so that after the mounting base 100 is separated from the shower head 200, an outer surface of the mounting base 100 is flush, so as to improve the aesthetics of the overall appearance after the mounting base 100 is separated from the shower head 200.

As shown in FIGS. 4 and 5, when the first snap-fit member 3 is in the snap-fit state, the pushing protrusion 92 of the shower head 200 can push the driving portion 32 to move toward the inner side of the mounting base 100, and the snap-fit portion 33 can move outward and extend out of the face cover 12 to be inserted into a snap-fit groove 91 of the shower head 200 (see below for detailed description). In this way, the snap-fit connection between the mounting base 100 and the shower head 200 is realized.

As shown in FIG. 5, the protruding end of the snap-fit portion 33 may be provided with a first guide inclined surface, so that the snap-fit portion 33 as a whole may be wedge-shaped. The first guide inclined surface can play a guide role when the snap-fit portion 33 snap-fits with the shower head 200, so that the snap-fit portion 33 can be smoothly snapped into the shower head 200.

In order to realize that the center of gravity of the first snap-fit member 3 is located on a side of the rotation axis 5 of the first snap-fit member 3 close to the driving portion 32, a dimension of the driving portion 32 in an up-down direction is set to be larger than a dimension of the snap-fit portion 33 in the up-down direction. In this way, the weight of the driving portion 32 is larger than the weight of the snap-fit portion 33, and the center of gravity of the entire first snap-fit member 33 is biased to a side on which the driving portion 32 is located. Further, setting the dimension of the driving portion 32 in the up-down direction to be larger than the dimension of the snap-fit portion 33 in the up-down direction is advantageous to increasing the area of the contact surface between the driving portion 32 and the pushing protrusion 92 of the shower head 200. This ensures that the pushing protrusion 92 of the shower head 200 can come into contact with the driving portion 32 of the first snap-fit member 3 and push the first snap-fit member 3 to rotate.

Alternatively, the center of gravity of the first snap-fit member 3 may be located on the side of the rotation axis 5 of the first snap-fit member 3 close to the driving portion 32 by other means, such as by providing a counterweight block on the first snap-fit member 3. The counterweight block and the driving portion 32 may be located on a same side of the rotation axis 5 of the first snap-fit member 3.

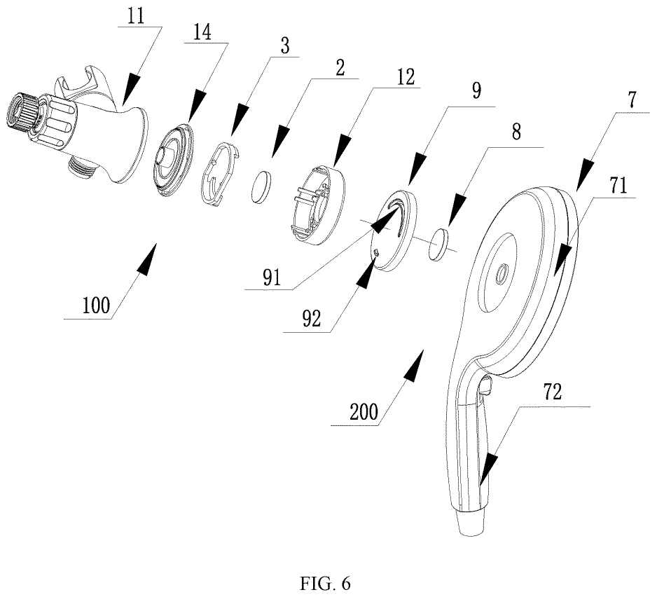

In some exemplary embodiments, as shown in FIGS. 6, 7 and 10, the first magnetic member 2 is cylindrical, the first slot 121 is a first circular arc groove, and a central axis of the first circular arc groove (an axis passing through a center of the first circular arc groove) 6-I coincides with the center line 6 (see FIG. 2) of the first magnetic member. The first slot 121 is configured to allow the pushing protrusion 92 of the shower head 200 to swing around the center line 6 of the first magnetic member in the snap-fit state so as to adjust the position of the shower head 200 with respect to the mounting base 100.

The first magnetic member 2 is cylindrical. To match the cylindrical first magnetic member 2, the first slot 121 is provided as a first circular arc groove, and its central axis 6-I coincides with the center line 6 of the first magnetic member. In this way, when the shower head 200 is installed on the mounting base 100, if the shower head 200 is not placed in a vertical state shown in FIG. 13(b), but is placed in an inclined state shown in FIG. 13(a) or FIG. 13(c), at this time, the shower head 200 can rotate around the center line 6 of the first magnetic member relative to the mounting base 100 under the action of its own gravity, and the pushing protrusion 92 of the shower head 200 can swing in the first slot 121 of the mounting base 100. This enables the shower head 200 to automatically return from the inclined state shown in FIG. 13(a) or FIG. 13(c) to the vertical state shown in FIG. 13(b), achieving the automatic alignment of the shower head 200 even after it is placed at an angle, and enhancing the convenience of installing the shower head 200 onto the mounting base 100.

In some exemplary embodiments, as shown in FIGS. 3 to 5, the driving portion 32 includes a driving surface 321, which has a circular arc shape extending along a circumferential direction of the first magnetic member 2. The driving surface 32 is configured to slidably abut against the pushing protrusion 92 of the shower head 200 (i.e., capable of abutting and relatively sliding in an abutting state), so that the pushing protrusion 92 of the shower head 200 can abut against the driving surface 32, enabling the pushing protrusion 92 to push the driving portion 32. This causes the first snap-fit member 3 to rotate, thereby causing the first snap-fit member 3 to be in the snap-fit state. When the first snap-fit member 3 is in the snap-fit state and the shower head 200 rotates relative to the mounting base 100 to adjust the position of the shower head 200 relative to the mounting base 100, the pushing protrusion 92 can slide on the driving surface 321 while maintaining abut against the driving surface 321. The driving surface 321 is designed as a circular arc shape extending in the circumferential direction of the first magnetic material 6, facilitating the pushing protrusion 92 to slide with respect to the driving surface 321 in a state in which the pushing protrusion 92 abuts against the driving surface 321.

As shown in FIGS. 8 and 9, the entire driving portion 32 may be a circular arc-shaped protrusion extending in the circumferential direction of the first magnetic member 2, and an end surface of a protruding end thereof forms the driving surface 321 that is a circular arc-shaped plane.

In some exemplary embodiments, as shown in FIGS. 3 and 5, the first slot 121 includes a first wall surface 1211 away from the second slot 122, and one end of the first wall surface 1211 close to the outer surface of the face cover 12 is inclined toward a side close to the second slot 122.

The first slot 121 includes a first wall surface 1211, and the first wall surface 1211 is used to enclose the first slot 121, and can be a lower wall surface of the first slot 121. A side of the first wall surface 1211 close to the outer surface of the face cover 12 is inclined towards the side close to the second slot 122, that is, the side of the first wall surface 1211 close to the outer surface of the face cover 12 is inclined upward. Therefore, after the shower head 200 shown in FIGS. 5 and 6 is installed on the mounting base 100, the pushing protrusion 92 can extend into the first slot 121. The inclined first wall surface 1211 of the first slot 121 can prevent the pushing protrusion 92 from automatically disengaging from the first slot 121. This in turn helps ensure that the snap-fit member 3 remains in the snap-fit state under the action of the pushing protrusion 92, thereby enhancing the connection stability between the shower head 200 and the mounting base 100.

In some exemplary embodiments, as shown in FIGS. 8 to 10, the snap-fit portion 33 includes a circular arc-shaped protrusion, and a central axis of the circular arc-shaped protrusion (an axis passing through a center of the circular arc-shaped protrusion) 6-II coincides with the center line 6 (see FIG. 2) of the first magnetic member. The second slot 122 is a second circular arc groove that matches the shape of the snap-fit portion 33, and a central axis of the second circular arc groove (an axis passing through a center of the second circular arc groove) 6-III coincides with the center line 6 of the first magnetic member.

The snap-fit portion 33 is a circular arc-shaped protrusion. To match the shape of the snap-fit portion 33, the second slot 122 is a second circular arc groove, and a central axis 6-II of the circular arc-shaped protrusion and a central axis 6-III of the second circular arc groove coincide with the center line 6 of the first magnetic member. In this way, when the shower head 200 is installed on the mounting base 100, if the shower head 200 is not placed in the vertical state shown in FIG. 13(b), but is placed in the inclined state shown in FIG. 13(a) or FIG. 13(c), at this time, the shower head 200 can rotate with respect to the mounting base 100 under the action of its own gravity, and the snap-fit portion 33 can slide in the snap-fit groove 91 of the shower head 200. This enables the shower head 200 to automatically return from the inclined state shown in FIG. 13(a) or FIG. 13(c) to the vertical state shown in FIG. 13(b), achieving the automatic alignment of the shower head 200 even after it is placed at an angle, and enhancing the convenience of installing the shower head 200 onto the mounting base 100.

The dimension of the driving portion 32 in the up-down direction is set to be larger than the dimension of the snap-fit portion 33 in the up-down direction. In order to match the dimensions of the driving portion 32 and the snap-fit portion 33, a radial width of the first circular arc groove (that is, a dimension of the first slot 121 in the up-down direction) is set to be larger than a radial width of the second circular arc groove (that is, a dimension of the second slot 122 in the up-down direction).

In some exemplary embodiments, as shown in FIGS. 2 to 8, an inner surface of the face cover 12 is provided with a first mounting groove 123 for mounting the first magnetic member 2, and the base body 1 further includes a magnetic member bracket 14. The magnetic member bracket 14 is positioned in the accommodation cavity 13 and abuts against the first magnetic member 2 to fix the first magnetic member 2 in the first mounting groove 123. To match the shape of the cylindrical first magnetic member 2, the first mounting groove 123 may be a cylindrical groove.

The snap-fit member body 31 has a through-hole. The magnetic member bracket 14 can pass through the through-hole so as to abut against the first magnetic member 2 and fix the first magnetic member 2 in the first mounting groove 123.

The face cover 12 is provided with a rotary support portion located outside the first mounting groove 123, and the rotary connection portions 34a and 34b of the first snap-fit member 3 rotatably cooperate with the rotary support portion. Two rotary support portions may be provided (only one rotary support portion 124 is shown in FIG. 8, and the other rotary support portion is not shown), and may be provided with a cylindrical shaft hole. In the first snap-fit member 3, two cylindrical convex posts may be provided on the inner side surface of the snap-fit member body 31 to form the rotary connection portions 34a, 34b respectively. The two cylindrical convex posts may be inserted into the shaft holes of the two rotary support portions respectively, and the convex posts may rotate in the shaft holes to realize rotary cooperation between the rotary connection portions 34a, 34b and the rotary support portions. Therefore, the first snap-fit member 3 can rotate relative to the base body 1 to realize the switching between the snap-fit state and the released state.

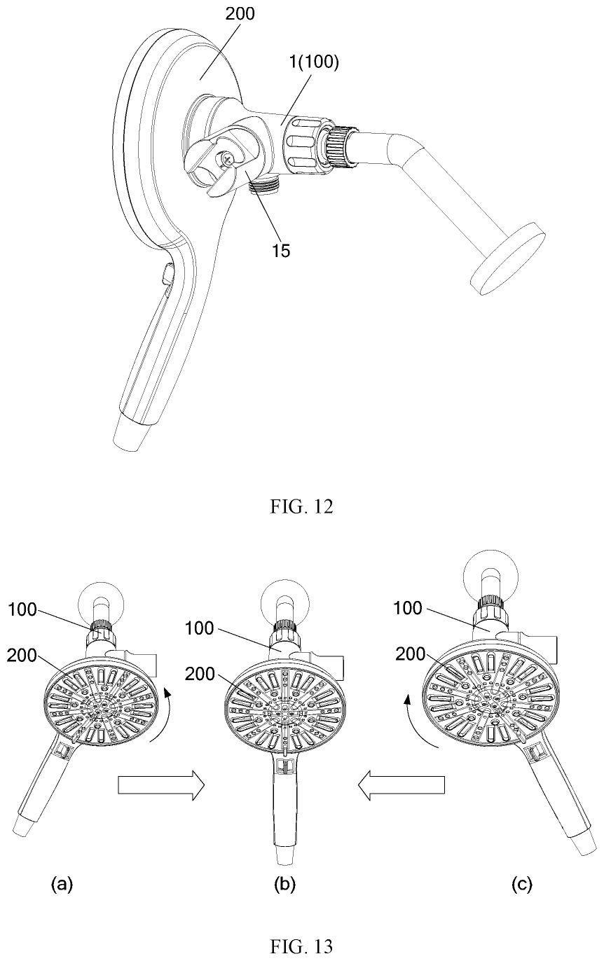

In some exemplary embodiments, as shown in FIG. 12, the mounting base 100 further includes an insertion portion 15, and the insertion portion 15 is located on one side outside the base body 1 and connected to the base body 1. That is, the insertion portion 15 is mounted to one side of the base body 1. The insertion portion 15 is configured for insertion fixation with the shower head 200.

In the mounting base 100, the base body 1 can be fixed to the wall body, and the face cover 12 can be located at the front part of the base body 1, that is, a side away from the wall body, so that the shower head 200 can be fixed to the front side of the mounting base 100 by a cooperative fixing mode combining magnetic attraction and snap-fit. The insertion portion 15 can be fixed outside one side of the base body 1. For example, the insertion portion 15 can be fixed to the left or right side of the base body 1, so that the shower head 200 can be inserted into the insertion portion 15, that is, the shower head 200 can be inserted into and fixed to the left or right side of the mounting base 100.

When the shower head 200 is fixed to the mounting base 100, the shower head 200 can be fixed on the front side of the mounting base 100, or fixed on the left or right side of the mounting base 100 according to the requirement. That is, the mounting base 100 can fix the shower head 200 through the first magnetic member 2 and the first snap-fit member 3, or fix the shower head 200 in an insertion manner through the insertion portion 15, so that the shower head 200 can have different heights to meet the usage requirement of people with different heights.

An embodiment of the present application provides a shower head 200, as shown in FIGS. 1 to 12, including a shower head body 7, a second magnetic member 8, and a second snap-fit member 9. The second magnetic member 8 and the second snap-fit member 9 are both installed to the shower head body 7.

The shower head 200 can be used cooperatively with the mounting base 100 provided in any of the above embodiments. The second magnetic member 8 of the shower head 200 is configured to be magnetically attracted to the first magnetic member 2 of the mounting base 100, and the second snap-fit member 9 of the shower head 200 is configured to snap-fit with the first snap-fit member 3 of the mounting base 100.

Both the first magnetic member 2 and the second magnetic member 8 may be magnets, or one of the first magnetic member 2 and the second magnetic member 8 may be a magnet, and the other of the first magnetic member 2 and the second magnetic member 8 may be made of a soft magnetic material. For example, the material of the other of the first magnetic member 2 and the second magnetic member 8 may be iron and the like, which are materials capable of being attracted by the magnet.

In some exemplary embodiments, as shown in FIGS. 2 to 7, the shower head body 7 includes a spray head 71 and a gripping portion 72 connected to each other, and the second snap-fit member 9 is provided on a side of the spray head 71 facing away from a water outlet side. The second snap-fit member 9 includes a snap-fit groove 91 located on a side of the second magnetic member 8 away from the gripping portion 72, and the snap-fit groove 91 is configured to snap-fit with the snap-fit protrusion of the first snap-fit member 3.

In the shower head body 7, the gripping portion 72 is connected to a lower side of the spray head 71, and the spray head 71 may have a water outlet located on the front side. The second magnetic member 8 and the second snap-fit member 9 may be mounted to the spray head 71, and the second snap-fit member 9 is opposite to the water outlet side (i.e., the front side) of the spray head 71, and may be located on the rear side of the spray head 71. The second snap-fit member 9 includes a snap-fit groove 91, and the snap-fit groove 91 is located on the side of the second magnetic member 8 away from the gripping portion 72, that is, the snap-fit groove 91 may be located on the upper side of the second magnetic member 8. When the shower head 200 is mounted to the mounting base 100, the shower head 200 can be mounted to the mounting base 100 from the front to the rear, the second magnetic member 8 can be magnetically fixed with the first magnetic member 2, and the snap-fit groove 91 on the rear side of the shower head body 7 can snap-fit with the snap-fit portion 33 of the mounting base 100 extending out of the face cover 12, so as to realize the snap-fit fixation between the shower head 200 and the mounting base 100.

As shown in FIG. 5, a second guide inclined surface is provided on an inner side wall surface of the snap-fit groove 91, so that the snap-fit groove 91 as a whole can be a wedge-shaped groove with a larger opening. The second guide inclined surface of the snap-fit groove 91 can play a guide role when the snap-fit portion 33 of the mounting base 100 snap-fits with the snap-fit groove 91, facilitating the snap-fit of the snap-fit portion 33 and the snap-fit groove 91, and enabling the second snap-fit member 9 to smoothly snap-fit with and be connected to the mounting base 100. It should be understood that in order to guide during snap-fit and facilitate snap-fit of the snap-fit portion 33 and the snap-fit groove 91, a first guide inclined surface may be provided on the snap-fit portion 33 and a second guide inclined surface may be provided on the snap-fit groove 91. Alternatively, the first guide inclined surface is provided only on the snap-fit portion 33. Alternatively, the second guide inclined surface is provided only on the snap-fit groove 91.

In some exemplary embodiments, as shown in FIGS. 6, 7 and 11, the second magnetic member 8 is cylindrical, the snap-fit groove 91 is a third circular arc groove, and a central axis of the third circular arc groove (an axis passing through a center of the third circular arc groove) 9-I coincides with the center line 81 (see FIG. 2) of the second magnetic member. As shown in FIG. 5, the snap-fit groove 91 is configured to allow the snap-fit protrusion (snap-fit portion 33) of the mounting base 100 to slide, so as to adjust the position of the shower head with respect to the mounting base 100.

The second magnetic member 8 is cylindrical, and to match the cylindrical second magnetic member 8, the snap-fit groove 91 is set as a third circular arc groove, and its central axis 9-I coincides with the center line 81 of the second magnetic member. In this way, when the shower head 200 is installed on the mounting base 100, under the magnetic attraction force between the first magnetic member 2 and the second magnetic member 8, the shower head 200 can be magnetically fixed to the mounting base 100, and the center line 6 of the cylindrical first magnetic member coincides with the center line 81 of the cylindrical second magnetic member. Consequently, the central axis 6-I of the first circular arc groove (first slot 121) of the mounting base 100, the central axis 6-III of the second circular arc groove (second slot 122), the central axis 6-II of the arc-shaped protrusion (the snap-fit portion 33), and the central axis 9-I of the third circular arc groove all coincide. Thus, when the shower head 200 is installed onto the mounting base 100, if the shower head 200 is not placed in the vertical state as shown in FIG. 13(b), but placed in the inclined state as shown in FIG. 13(a) or FIG. 13(c), at this time, the shower head 200 can rotate relative to the mounting base 100 under the action of its own gravity, the pushing protrusion 92 of the shower head 200 can slide in the first slot 121 of the mounting base 100, and the arc-shaped protrusion (the snap-fit portion 33) of the mounting base 100 can slide within the snap-fit groove 91. This enables the shower head 200 to automatically return from the inclined state shown in FIG. 13(a) or FIG. 13(c) to the vertical state shown in FIG. 13(b), thus achieving the automatic alignment of the shower head 200 even after it is placed at an angle.

For the mounting base 100 and the shower head 200 according to the embodiment of the present application, when the shower head 200 is mounted to the mounting base 100, the shower head 200 does not need to be mounted in a vertical state. The shower head 200 can automatically return to the vertical state even if the shower head 200 is inclined, thereby improving the convenience when the shower head 200 is mounted to the mounting base 100.

In some exemplary embodiments, as shown in FIGS. 2, 4-5, and 11, the second snap-fit member 9 further includes a pushing protrusion 92 located on a side of the second magnetic member 8 close to the gripping portion 72. The pushing protrusion 92 is configured to push the driving portion 32 of the first snap-fit member 3 to rotate the first snap-fit member 3.

The second snap-fit member 9 includes a pushing protrusion 92, which can protrude toward the rear side of the shower head 200. The pushing protrusion 92 can be located on the side of the second magnetic member 8 close to the grip portion 72, that is, the pushing protrusion 92 can be located on the lower side of the second magnetic member 8. In this way, the pushing protrusion 92 located on the lower side can cooperate with the first slot 121 and the driving portion 32 of the mounting base 100 located on the lower side, so that the pushing protrusion 92 can push the driving portion 32 after passing through the first slot 121, causing the first snap-fit member 3 to rotate, and realizing the switching of the first snap-fit member 3 from the released state to the snap-fit state.

In some exemplary embodiments, as shown in FIG. 5, the pushing protrusion 92 includes a second wall surface 921 away from the snap-fit groove 91, and a side of the second wall surface 921 close to a protruding end of the pushing protrusion 92 is inclined toward a side away from the snap-fit groove 91.

The pushing protrusion 92 includes a second wall surface 921, which is positioned away from the snap-fit groove 91, that is, the second wall surface 921 may be a lower wall surface of the pushing protrusion 92. A side of the second wall surface 921 close to the protruding end of the pushing protrusion 92 is inclined toward the side away from the snap-fit groove 91, that is, the rear side of the second wall surface 921 can be inclined downward. The second wall surface 921 can cooperate with the inclined first wall surface 1211 of the first slot 121 to prevent the pushing protrusion 92 from automatically coming out of the first slot 121. This in turn helps ensure that the first snap-fit member 3 maintains in the snap-fit state under the action of the pushing protrusion 92, enhancing the connection stability between the shower head 200 and the mounting base 100.

In some exemplary embodiments, the cylindrical first magnetic member 2 and the cylindrical second magnetic member 8 have equal diameters.

It should be noted that the first snap-fit member 3, the first slot 121, and the second slot 122 may be provided in the shower head 200; the second snap-fit member 9 (including the snap-fit groove 91, the pushing protrusion 92) may be provided in the mounting base 100. That is, one of the shower head 200 and the mounting base 100 is provided with structures such as the first snap-fit member 3, the first slot 121, and the second slot 122, and the other of the shower head 200 and the mounting base 100 is provided with the second snap-fit member 9.

In some exemplary embodiments, a second mounting groove is formed between the second snap-fit member 9 and the shower head body 7, and the second magnetic member 8 can be mounted in the second mounting groove. The second mounting groove may be a cylindrical groove and may be integrally formed on the second snap-fit member 9. Alternatively, the second mounting groove may be provided on the shower head body 7.

An embodiment of the present application provides a shower head assembly, as shown in FIGS. 1 to 13, including the mounting base 100 provided by any one of the above embodiments and the shower head 200 provided by any one of the above embodiments. The shower head 200 is arranged to be mountable to the mounting base 100.

The shower head assembly described in the embodiment of the present application includes the mounting base 100 and the shower head 200 of any of the above embodiments, and thus includes the structural features and advantages of the mounting base 100 and the shower head 200 of any of the above embodiments, and will not be repeated herein.

In summary, in the shower head assembly of the embodiment of the present application, the first snap-fit member 3 and the first magnetic member 2 are arranged on the mounting base 100, and the second snap-fit member 9 is arranged on the shower head 200 to realize the fixation of both magnetic attraction and snap-fit between the shower head 200 and the mounting base 100. Moreover, the mounting base 100 has a simple structure, beautiful appearance, and is easy to process and manufacture. This avoids setting a large boss in a center area of a front end surface of the mounting base, which could otherwise lead to the problem that the mounting base has an unconcise and unattractive design. In addition, the structural arrangement of the mounting base 100 and the shower head 200 according to the embodiment of the present application can also realize the automatic alignment of the shower head 200 after being placed obliquely, so that the use and operation of the shower head 200 are more convenient.

In the description of the present disclosure, it should be noted that the orientation or position relationships indicated by the terms “one side”, “the other side”, “one end”, “the other end”, “side edge”, “relative” or the like are based on the orientation or position relationships shown in the drawings, which are only for convenience of describing the present application and simplifying the description, rather than indicating or implying that the structure referred has the specific orientation, or is constructed and operated in the specific orientation, and thus cannot be interpreted as a limitation on the present disclosure.

In the description of embodiments of the present application, the terms “connection”, “fix”. and “mounting” and the like should be understood broadly unless otherwise expressly specified and limited. For example, the term “connection” may be a fixed connection, may be a detachable connection, or may be an integrated connection. The term “connection” may be a direct connection or an indirect connection through an intermediate medium, and may be an internal communication between two elements. For those of ordinary skills in the art, the specific meanings of the aforementioned terms in the present disclosure may be understood according to specific situation.

Furthermore, the terms “first” and “second” are only used for descriptive purposes and cannot be understood as indicating or implying relative importance or implying the quantity of technical features indicated. Thus, features defined by “first” or “second” may explicitly or implicitly include at least one of the features.

In the description of the present application, descriptions with reference to terms “one embodiment”, “some embodiments”, “example”, “specific example”, or “some examples”, and the like mean that specific features, structures, materials, or characteristics described in conjunction with the embodiment or example are included in at least one embodiment or example of the present application. In this specification, the schematic illustration of the above terms does not need to be directed to the same embodiments or examples. Further, the specific features, structures, materials, or characteristics described may be combined in a suitable manner in any one or more embodiments or examples. Further, those skilled in the art may incorporate and combine different embodiments or examples and features of different embodiments or examples described in this specification if there is no conflict.

Although implementations disclosed herein are described above, the described contents are only implementations used for facilitating understanding of the present application, and are not intended to limit the present application. Without departing from the spirit and scope disclosed herein, any person skilled in the art to which the present application pertains may make any modifications and changes in the form and details of implementation, but the scope of patent protection of the present application shall still be defined by the appended claims.

What is claimed is:

1. A mounting base comprising: a base body, a first magnetic member, and a first snap-fit member, the first magnetic member and the first snap-fit member being both mounted to the base body;
wherein the first magnetic member is configured to be magnetically attracted to a mounting member mounted to the base body, and the first snap-fit member is configured to snap-fit with the mounting member.

2. The mounting base according to claim 1, wherein the first snap-fit member comprises a snap-fit member body, and a driving portion and a snap-fit portion provided on the snap-fit member body,
the snap-fit member body is movably connected to the base body so that the first snap-fit member has a snap-fit state and a released state, wherein in the snap-fit state, the snap-fit portion is configured to be capable of snap-fitting with the mounting member; in the released state, the snap-fit portion is configured to be detachable from the mounting member; and
the driving portion is configured to be movable under an action of the mounting member to switch the first snap-fit member from the released state to the snap-fit state.

3. The mounting base according to claim 2, wherein the snap-fit member body is provided with a rotary connection portion, the rotary connection portion is rotatably connected with the base body, and a rotation axis of the first snap-fit member perpendicularly intersects with a center line of the first magnetic member; and
the driving portion and the snap-fit portion are respectively located on both sides of the rotation axis of the first snap-fit member, and are arranged opposite to each other.

4. The mounting base according to claim 3, wherein a center of gravity of the first snap-fit member is located on a side of the rotation axis of the first snap-fit member close to the driving portion, and the first snap-fit member is configured to be held in the released state under an action of its own weight; or
the mounting base further comprises an elastic resetting member provided between the first snap-fit member and the base body, and the first snap-fit member is configured to be held in the released state under an action of the elastic resetting member.

5. The mounting base according to claim 3, wherein the base body comprises a support seat and a face cover, the support seat and the face cover cooperating to form an accommodation cavity, the snap-fit member body being mounted in the accommodation cavity, and
the face cover is provided with a first slot, and the first slot is configured to allow a pushing protrusion of the mounting member to pass through so as to push the driving portion; the face cover is provided with a second slot, and the snap-fit portion is configured to be capable of passing through the second slot to snap-fit with the mounting member.

6. The mounting base according to claim 5, wherein the driving portion comprises a driving protrusion provided on an end surface on a side of the snap-fit member body close to the face cover, and the snap-fit portion comprises a snap-fit protrusion provided on the end surface on the side of the snap-fit member body close to the face cover; and
in the released state, the driving portion is configured to protrude into the first slot and not protrude from an outer surface of the face cover; the snap-fit portion is configured to protrude into the second slot and not protrude from the outer surface of the face cover.

7. The mounting base according to claim 5, wherein the first magnetic member is cylindrical, the first slot is a first circular arc groove, and a central axis of the first circular arc groove coincides with the center line of the first magnetic member; and
the first slot is configured to allow the pushing protrusion of the mounting member to swing around the center line of the first magnetic member in the snap-fit state to adjust a position of the mounting member relative to the mounting base.

8. The mounting base according to claim 7, wherein the driving portion comprises a driving surface, and the driving surface has a circular arc shape extending in a circumferential direction of the first magnetic member; and
the driving surface is configured to slidably abut against the pushing protrusion of the mounting member.

9. The mounting base according to claim 5, wherein the snap-fit portion comprises a circular arc-shaped protrusion, and a central axis of the circular arc-shaped protrusion coincides with the center line of the first magnetic member; and
the second slot is a second circular arc groove that matches a shape of the snap-fit portion, and a central axis of the second circular arc groove coincides with the center line of the first magnetic member.

10. The mounting base according to claim 5, wherein the first slot comprises a first wall surface away from the second slot, an end of the first wall surface close to an outer surface of the face cover being inclined toward a side close to the second slot.

11. The mounting base according to claim 5, wherein an inner surface of the face cover is provided with a first mounting groove for mounting the first magnetic member, the base body further comprises a magnetic member bracket, and the magnetic member bracket is positioned in the accommodation cavity and abuts against the first magnetic member to secure the first magnetic member in the first mounting groove;
the face cover is provided with a rotary support portion located outside the first mounting groove, and the rotary connection portion rotatably cooperates with the rotary support portion; and
the snap-fit member body has a through-hole through which the magnetic member bracket passes.

12. The mounting base according to claim 1, further comprising an insertion portion mounted to one side of the base body;
wherein the mounting base is configured to fix the mounting member by the first magnetic member and the first snap-fit member, or to fix the mounting member in an insertion manner by the insertion portion.

13. A shower head comprising: a shower head body, a second magnetic
member, and a second snap-fit member, the second magnetic member and the second snap-fit member being both mounted to the shower head body;
wherein the second magnetic member is configured to be magnetically attracted to the first magnetic member of the mounting base according to claim 1, and the second snap-fit member is configured to snap-fit with the first snap-fit member of the mounting base.

14. The shower head according to claim 13, wherein the shower head body comprises a spray head and a gripping portion connected to each other, the second magnetic member and the second snap-fit member are both mounted to the spray head, and the second snap-fit member is provided on a side of the spray head facing away from a water outlet side, and the second snap-fit member comprises a snap-fit groove located on a side of the second magnetic member away from the gripping portion, and the snap-fit groove is configured to snap-fit with a snap-fit protrusion of the first snap-fit member.

15. The shower head according to claim 14, wherein the second magnetic member is cylindrical, the snap-fit groove is a third circular arc groove, and a central axis of the third circular arc groove coincides with a center line of the second magnetic member; and
the snap-fit groove is configured to allow the snap-fit protrusion to swing around the center line of the second magnetic member when the snap-fit protrusion snap-fits with the snap-fit groove to adjust a position of the shower head relative to the mounting base.

16. The shower head according to claim 14, wherein the second snap-fit member further comprise a pushing protrusion located on a side of the second magnetic member close to the gripping portion, and the pushing protrusion is configured to push a driving portion of the first snap-fit member to rotate the first snap-fit member.

17. The shower head according to claim 16, wherein the pushing protrusion comprises a second wall surface away from the snap-fit groove, and a side of the second wall surface close to a protruding end of the pushing protrusion is inclined toward a side away from the snap-fit groove.

18. A shower head assembly comprising the mounting base according to claim 1 and a shower head, wherein the shower head comprises: a shower head body, a second magnetic member, and a second snap-fit member, the second magnetic member and the second snap-fit member being both mounted to the shower head body;
wherein the second magnetic member is configured to be magnetically attracted to the first magnetic member of the mounting base, and the second snap-fit member is configured to snap-fit with the first snap-fit member of the mounting base, and
wherein the shower head is configured to be mountable to the mounting base.

19. The shower head assembly according to claim 18, wherein a center line of the first magnetic member and a center line of the second magnetic member are collinear when the second magnetic member of the shower head is magnetically attracted to the first magnetic member of the mounting base and the second snap-fit member of the shower head snap-fits with the first snap-fit member of the mounting base.

20. The mounting base according to claim 6, wherein an inner surface of the face cover is provided with a first mounting groove for mounting the first magnetic member, the base body further comprises a magnetic member bracket, and the magnetic member bracket is positioned in the accommodation cavity and abuts against the first magnetic member to secure the first magnetic member in the first mounting groove;
the face cover is provided with a rotary support portion located outside the first mounting groove, and the rotary connection portion rotatably cooperates with the rotary support portion; and
the snap-fit member body has a through-hole through which the magnetic member bracket passes.
